(19) United States
(12) Patent Application Publication
(10) Pub. No.: US 2026/0276860 A1
(43) Pub. Date: Sep. 17, 2026

(54) Gravitational Information Extraction Device for Recognition-Weighted Multiscale Analysis of Gravitational Wave Signals

(71) Applicant: Jonathan Washburn, Austin, TX (US)

(72) Inventor: Jonathan Washburn, Austin, TX (US)

(21) Appl. No.: 19/563,751

(22) Filed: Mar. 11, 2026

Related U.S. Application Data
(60) Provisional application No. 63/770,735, filed on Mar. 12, 2025.

(51) Int. Cl. G01V 7/04

(52) U.S. Cl. CPC G01V 7/04

(57) ABSTRACT

A gravitational information extraction device detects, analyzes, and extracts informational content from gravitational wave signals. A sensor subsystem generates measurement data responsive to gravitational-wave-induced effects, and processing circuitry derives a recognition signal parameter from amplitude, frequency, and time quantities associated with the measurement data. The processing circuitry computes a bounded recognition coverage quantity, applies scale-dependent recognition weighting to generate multiscale recognition transforms, identifies structured informational features from the transforms, and computes one or more informational content quantities. The device generates outputs including event indicators, classifications, reports, or correlation results. In some embodiments, the device includes a quantum enhancement subsystem configured to improve measurement sensitivity. In some embodiments, recognition-transform results from multiple detectors are time-synchronized and phase-synchronized for cross-correlation. The disclosed system supports extraction of structured information from gravitational wave measurements using recognition-weighted multiscale analysis.

### CROSS-REFERENCE TO RELATED APPLICATIONS

This application claims the benefit of U.S. Provisional Patent Application No. 63/770,735, filed Mar. 12, 2025, titled “Gravitational Information Extraction Device (GIED): A System for Detecting, Analyzing, and Extracting Informational Content from Gravitational Waves Using Recognition Physics Principles”, the entire disclosure of which is incorporated herein by reference.

### INCORPORATION BY REFERENCE

Each U.S. patent and U.S. patent application publication cited herein, if any, is incorporated by reference in its entirety. Any non-patent literature cited herein, if any, is incorporated by reference only for non-essential background information and not for any material that is necessary to satisfy the written description or enablement requirements.

### BACKGROUND

The present disclosure relates generally to gravitational wave detection, gravitational wave signal processing, and quantum-enhanced metrology. More particularly, the present disclosure relates to systems and methods for detecting and analyzing gravitational wave signals in a manner that supports extraction of structured informational content from measured gravitational wave data streams.

Gravitational waves can produce time-varying strain in spacetime that may be observed as differential changes in optical path length, phase, frequency, displacement, timing, or other physical observables. A variety of detector architectures have been developed or proposed for sensing such signals, including interferometric detectors, resonant mass detectors, atom interferometers, optical clock networks, superconducting gravimeters, and other sensor systems capable of converting gravitational-wave-induced effects into electrical, optical, mechanical, or quantum-state measurement signals.

In many existing gravitational wave observatories and analysis frameworks, detector outputs are processed to identify candidate events and to estimate astrophysical parameters associated with those events. For example, conventional processing may be directed to estimation of parameters such as source mass, spin, luminosity distance, sky position, waveform consistency, polarization content, or other source-characterization metrics. Such approaches have produced important results, but their principal optimization targets are often tied to parameter estimation, template agreement, detection significance, or source classification under established models.

Existing analysis pipelines commonly rely on signal-processing techniques such as Fourier analysis, short-time Fourier analysis, wavelet analysis, matched filtering, burst searches, stochastic background cross-correlation, and related time-frequency or model-based procedures.

These techniques can be highly effective for many classes of signals. However, in some circumstances, the selected representation, weighting, or detection statistic may emphasize only a subset of the structure present in the measured data.

In particular, some classes of latent or weakly expressed structure may depend on coupled amplitude-frequency-time behavior, scale-dependent coherence, persistent phase relationships, or other cross-scale organization that is not always emphasized by conventional fixed-weight or template-centered pipelines. As a result, information-bearing features that are not optimally represented in a standard Fourier, wavelet, or matched-filter framework may be reduced in prominence, dispersed across multiple analysis products, or treated as noise-like residual structure.

A further practical difficulty is that gravitational wave measurements are frequently obtained in the presence of nonstationary noise, instrumental artifacts, environmental couplings, calibration uncertainty, and detector-specific operating constraints. Under such conditions, extraction of subtle structure from a measured strain stream can depend heavily on analysis-window selection, thresholding choices, weighting schemes, normalization choices, empirical tuning, and other implementation details that may vary across instruments, frequency bands, and event classes.

Conventional systems also do not always provide a unified framework that jointly addresses sensor configuration, signal acquisition, and downstream information extraction according to a common design principle. In many settings, sensor geometry, quantum-noise mitigation, preprocessing, feature extraction, and multi-detector correlation are optimized in partially separate stages. This separation can make it difficult to define an end-to-end architecture directed specifically toward extraction of additional structured informational content from gravitational wave measurements.

In addition, although quantum-enhancement techniques such as squeezed-state injection and related noise-reduction methods have been investigated for improving detector sensitivity, such techniques are typically deployed to improve signal-to-noise characteristics within existing measurement and inference pipelines. A need remains for analysis architectures that can more directly coordinate enhanced acquisition sensitivity with downstream weighted, multiscale processing intended to preserve and extract structured signal content.

Multi-detector operation presents additional challenges. Global and space-based gravitational wave observations may depend on accurate timing alignment, phase consistency, calibration transfer, and cross-correlation across geographically separated or distributed platforms. Existing network analyses can be limited by implementation complexity, communication burdens, detector heterogeneity, and the difficulty of maintaining coherent combination of analysis products across multiple sites and operating conditions.

A further limitation in some existing approaches is reliance on empirical parameter tuning or detector-specific heuristics that may be difficult to audit, reproduce, or port across platforms.

Where system performance depends materially on ad hoc tuning choices, reproducibility and design transparency may be reduced, particularly when attempting to compare results across detector architectures, observing runs, or processing environments.

Accordingly, a need exists for improved gravitational wave detection and analysis systems that are capable of extracting structured informational content from gravitational wave signals beyond conventional parameter-estimation outputs, while remaining compatible with real-time or near-real-time operation, robust preprocessing, and multi-detector correlation.

A need further exists for such systems to support multiscale analysis of gravitational wave data, including analysis in which detectability may depend on nonstandard weighting, scale-sensitive coherence behavior, or joint amplitude-frequency-time relationships.

A need also exists for systems that can operate in conjunction with quantum-enhanced measurement hardware, can be implemented in interferometric and non-interferometric detector architectures, and can support distributed terrestrial or space-based detector networks.

A need further exists for detector and analysis frameworks that reduce dependence on purely empirical tuning by permitting explicit and reproducible design relationships, calibration seams, and processing definitions suitable for implementation across a range of sensor configurations and computational platforms.

The foregoing discussion is intended only to provide background context and is not an admission that any particular reference, system, technique, or limitation constitutes prior art to the claimed subject matter.

### SUMMARY OF THE INVENTION

In one aspect, the present disclosure provides a gravitational information extraction device configured to detect, analyze, and extract informational content from gravitational wave signals.

In various embodiments, the device includes a sensor subsystem configured to generate measurement data responsive to gravitational-wave-induced effects, processing circuitry configured to derive one or more signal quantities from the measurement data, and output circuitry configured to generate one or more reports, classifications, event indicators, informational content measures, or correlation results. The device may be implemented as a dedicated observatory system, as a retrofit module for an existing detector, as a hybrid hardware-software platform, or as part of a distributed detection architecture.

In some embodiments, the sensor subsystem comprises a recognition-optimized sensor array in which one or more physical or effective sensing dimensions are selected according to a recognition scaling relationship. In nonlimiting examples, the sensor subsystem may include an interferometric detector, a resonant mass detector, an atom interferometer, a clock-network detector, a superconducting gravimeter, or another measurement system configured to convert a gravitational-wave-induced effect into a measurable electrical, optical, mechanical, or quantum-state signal. In certain interferometric embodiments, an optical path length or effective optical path length is selected according to a recognition scaling relationship so as to support detection and downstream extraction of structured signal content.

In another aspect, the processing circuitry is configured to compute a recognition coverage quantity and one or more recognition-weighted transforms from the measurement data. In one embodiment, a dimensionless quantity r is derived from a strain-related amplitude measure, a frequency-related quantity, and a time-related quantity, and a recognition coverage function is computed from r. In a preferred embodiment, the recognition coverage function is bounded and monotone increasing for nonnegative input values, thereby supporting stable computation and interpretable weighting behavior. In some embodiments, informational content is further derived from the recognition coverage quantity by a monotone informational mapping.

In a further aspect, the present disclosure provides multiscale recognition transforms configured to analyze gravitational wave data across multiple scales, bands, windows, or transform settings.

In some embodiments, recognition weighting is incorporated into a Fourier-type transform. In other embodiments, recognition weighting may be applied to wavelets, chirplets, filterbanks, matched filters, or other transforms. Such multiscale processing can, in some embodiments, reveal structured features, coherence behavior, phase relationships, or other informational content not readily emphasized by conventional analysis pipelines.

In some embodiments, the device further includes a quantum enhancement subsystem configured to improve measurement sensitivity in one or more operating bands. The quantum enhancement subsystem may include, for example, a squeezing module configured to inject squeezed states or otherwise reduce measurement noise in a selected band or set of bands. In certain embodiments, the quantum enhancement subsystem operates in coordination with the sensor subsystem and the recognition-weighted processing chain so that increased measurement sensitivity is aligned with downstream extraction of structured informational content.

In another aspect, the present disclosure provides a distributed gravitational information extraction network including multiple detectors located at different terrestrial and/or space-based locations. In some embodiments, recognition-weighted transforms computed at different detectors are combined under time synchronization and phase synchronization constraints to support coherent cross-correlation, confidence enhancement, event validation, or extraction of distributed signal structure. In certain embodiments, recognition-phase synchronization includes maintaining a bounded phase difference between recognition transforms computed at different detectors after propagation-delay correction and calibration-offset compensation.

In still further embodiments, the present disclosure encompasses variations in the definition of the signal quantity r, variations in the form of the recognition coverage function, variations in the informational mapping, and variations in the transform domain, hardware architecture, and deployment environment. Thus, the disclosed subject matter is not limited to a single detector type, transform type, weighting function, quantum enhancement technique, or network configuration, but instead includes a range of implementations in which gravitational wave measurement data is processed using bounded recognition weighting and multiscale analysis to extract informational content from measured gravitational wave signals.

The system, method, and computer-readable-medium embodiments disclosed herein implement the same single inventive concept: (i) deriving a nonnegative recognition signal parameter r from detector measurement data, (ii) computing a bounded monotone increasing recognition coverage quantity from r, (iii) applying scale-dependent recognition weighting to compute one or more recognition-weighted transforms, (iv) extracting structured informational features and computing one or more informational content quantities, and (v) generating an output based on an objective decision criterion (for example, a threshold or coherence test). Optional elements described herein, including quantum enhancement (for example squeezing) and multi-detector time/phase-synchronized correlation, are disclosed as optional enhancements that operate on the same recognition-weighted processing chain and do not define separate unrelated inventions.

Subcombinations that include any subset of (i) recognition-optimized sensing, (ii) recognition coverage computation, (iii) recognition-weighted multiscale transforms, (iv) informational-content quantification and thresholding, (v) distributed correlation, and/or (vi) quantum enhancement are expressly contemplated as within the scope of the disclosure.

As used herein, “recognition” refers to the disclosed deterministic detector-data processing framework in which a nonnegative signal parameter is mapped to a bounded coverage quantity and, in some embodiments, further mapped to one or more informational-content quantities and one or more multiscale transform weightings. The term does not require cognition, subjective interpretation, or human recognition, but instead denotes algorithmic weighting, transform computation, feature extraction, and correlation operations performed on detector measurement data.

As used herein, “structured informational features” include one or more transform-domain features, coherence relationships, phase relationships, cross-scale signatures, time-frequency tile-level quantities, band-level quantities, and/or event-level quantities that are derived from, or computed using, recognition coverage quantities and recognition-weighted transforms applied to detector measurement data. In some embodiments, structured informational features include, by way of example and not limitation: persistent cross-scale ridges or tracks in a time-frequency representation; phase-consistent tile groupings across scales; inter-detector coherence or phase-difference-constrained features after propagation-delay correction; scale-dependent energy, entropy, kurtosis, sparsity, or concentration measures computed on recognition-weighted transform coefficients; and/or feature vectors formed by deterministic aggregation across windows, frequency bins, and/or scales. As used herein, an “informational content quantity” includes one or more scalar, vector, tile-based, band-based, event-level, or observation-level quantities computed to characterize informational structure present in the measured data and/or in the recognition-weighted transforms, including quantities formed by monotone mappings of bounded coverage values and deterministic aggregation followed by an objective decision criterion.

As used herein, a “recognition-weighted transform” is a transform in which a recognition coverage quantity (or a quantity deterministically derived from recognition coverage) is applied as a weight that affects transform computation for a window, tile, or sample set. In nonlimiting examples, the recognition coverage weight is applied (i) samplewise in the time domain prior to a discrete Fourier transform or other discrete transform, (ii) tilewise in a time-frequency representation prior to feature extraction or fusion, and/or (iii) coefficient-wise to transform outputs where the coefficient weighting is computed from r via the bounded coverage function and associated multiscale scaling. In multiscale embodiments, different branches use different scale indices n such that the recognition coverage weight in each branch follows F_cov,n(r)=r/(r+(X_opt\hat{ }n)), enabling cross-scale signature features and branch fusion operations that are defined by the bounded coverage construction rather than by arbitrary per-bin gain setting.

In embodiments, the disclosed arrangements provide technical improvements in detector-side processing by constraining coverage computation to bounded monotone behavior for nonnegative input values, improving computational stability through enforcement of nonnegative r and positive X_opt with optional clamping below unity, providing explicit scale-dependent weighting relationships for multiscale extraction, reducing reliance on empirical tuning through explicit recognition-scaling relationships, and enabling synchronized coherent combination of detector outputs under time and phase constraints. These improvements are implemented in physical detector acquisition and processing chains and in detector-network processing rather than in an abstract mathematical context.

In some embodiments, the recognition-weighted processing described herein is not a generic “weighting” of signal data, but instead is defined by a specific chained construction in which (a) a dimensionless nonnegative recognition signal parameter r is computed from amplitude, frequency, and time quantities derived from detector measurement data, (b) r is mapped through a bounded monotone increasing coverage function such as F_cov(r)=r/(r+X_opt) (and in multiscale form F_cov,n(r)=r/(r+(X_opt\hat{ }n))), and (c) the resulting bounded coverage values are used as scale-dependent weights that govern how transform-domain structure is emphasized across windows, scales, and bands. Because F_cov,n(r) is bounded and monotone for nonnegative r and positive X_opt, the weighting stage provides controlled saturation behavior and a consistent normalization behavior across different operating regimes, including low-signal and near-saturation regimes that can occur in nonstationary noise conditions. In some embodiments, the bounded coverage values are further mapped into informational-content quantities using a strictly monotone mapping such as I(r)=−log 2(1−F_cov(r)) (and in multiscale form I_n(r)=−log 2(1−F_cov,n(r))), and event-level quantities are formed by deterministic aggregation across windows, scales, and/or frequency bins followed by an objective decision rule (for example, threshold satisfaction or a coherence statistic exceeding a threshold after propagation-delay correction and calibration-offset compensation). In some embodiments, these coupled bounded weighting and informational mappings provide a technical improvement in gravitational-wave measurement processing by improving numerical stability of weighting across operating regimes, reducing reliance on ad hoc tuning, and producing scale-consistent multiscale signatures that support reproducible event indication, classification, validation, and/or coordinated multi-detector correlation in physical detector acquisition and processing chains.

### BRIEF DESCRIPTION OF THE DRAWINGS

FIG. 1 is a block diagram of an overall gravitational information extraction device architecture including a sensor subsystem, a quantum enhancement subsystem, data acquisition, recognition transform processing, pattern identification, information extraction, and outputs and/or network connectivity.

FIG. 2 is a diagram of a recognition-optimized interferometric sensor geometry showing optical path length selection, including a physical arm length and an effective optical path length realized by one or more cavities.

FIG. 3 is a graph of a recognition coverage function showing boundedness and monotonic increase as a function of a recognition signal parameter.

FIG. 4 is a conceptual diagram of a multiscale recognition transform showing parallel processing across multiple scales and fusion of resulting analysis outputs.

FIG. 5 is a graph of an informational content mapping showing behavior in a low-signal regime and in a near-saturation regime.

FIG. 6 is a diagram of a distributed gravitational information extraction network showing time synchronization, phase synchronization, and cross-correlation of recognition transforms across multiple detectors.

FIG. 7 is an optical layout of a quantum squeezing module including squeezed-state generation, a filter cavity, and injection into an interferometric readout chain.

FIG. 8 is a flowchart of a signal processing pipeline including preprocessing, computation of a recognition signal parameter, computation of a recognition coverage quantity, transform computation, classification, and reporting.

### DETAILED DESCRIPTION

FIG. 1 illustrates a gravitational information extraction device architecture in which a sensor subsystem 10 is configured to generate measurement data responsive to a gravitational-wave-induced effect, and an optional quantum enhancement subsystem 12 is arranged to improve measurement sensitivity in one or more operating bands. In the illustrated embodiment, the output of the sensor subsystem 10 is provided to a data acquisition subsystem 14 that performs digitization, time stamping, buffering, and streaming of measurement data for downstream processing. A recognition transform processing subsystem 16 receives the acquired data and computes recognition-weighted quantities, including recognition coverage values and recognition transforms. A pattern identification subsystem 18 operates on outputs of the recognition transform processing subsystem 16 to identify structured features in the measured data, and an information extraction subsystem 20 quantifies informational content associated with the identified features. The resulting outputs are provided through an output subsystem 22, and in some embodiments are also provided through a network interface 24 for communication to external processing nodes, data stores, or distributed detector systems.

In one embodiment, the sensor subsystem 10 comprises an interferometric gravitational-wave detector configured to measure differential optical path length changes associated with spacetime strain. In other embodiments, the sensor subsystem 10 may comprise another detector type capable of generating a signal proportional to a gravitational-wave-induced observable. The quantum enhancement subsystem 12 may be omitted in some embodiments, and where present may include a squeezing arrangement or another quantum enhancement arrangement configured to reduce measurement noise or otherwise improve sensitivity. The data acquisition subsystem 14 may include an analog front end, anti-alias filtering, analog-to-digital conversion, and timing circuitry. The recognition transform processing subsystem 16 may be implemented in hardware, software, firmware, or combinations thereof, and is configured to compute one or more recognition coverage quantities and one or more recognition-weighted transforms from the measurement data.

In the embodiment of FIG. 1, the pattern identification subsystem 18 may generate one or more event indicators, classes, or confidence measures from outputs of the recognition transform processing subsystem 16. The information extraction subsystem 20 may compute one or more informational content quantities, including tile-level, band-level, and event-level quantities, from recognition-weighted processing results. The output subsystem 22 may generate reports, trigger messages, catalogs, or other outputs that characterize detected structure in the measured data.

Where the network interface 24 is present, the device may transmit raw measurement data, recognition transforms, extracted features, informational content measures, or combinations thereof to a local or remote destination. In this manner, FIG. 1 shows an end-to-end architecture that carries measured detector data from acquisition through recognition-weighted processing, pattern identification, information quantification, and output generation.

The architecture of FIG. 1 may be implemented as a dedicated observatory system, as a retrofit module added to an existing detector, as a hybrid arrangement receiving external detector data, or as part of a distributed deployment spanning multiple locations. Accordingly, FIG. 1 is intended to illustrate functional organization rather than to limit the invention to a single hardware partitioning. Components shown separately may be integrated, and components described together may be separated across different processors, boards, instruments, or sites.

FIG. 2 illustrates a recognition-optimized interferometric sensor geometry. In the illustrated embodiment, a laser subsystem 30 directs coherent optical radiation to a beam splitter 32 that divides the optical field into a first arm 34 and a second arm 36. The first arm 34 includes a first cavity 38 terminated by a first end mirror 42, and the second arm 36 includes a second cavity 40 terminated by a second end mirror 44. Recombined light is directed to a readout photodetector 46. A physical arm length 48 is associated with one or more physical optical paths defined by the first arm 34 and the second arm 36, while an effective optical path length 50 represents a cavity-enhanced or folded-path optical length that may exceed the physical arm length 48.

In one embodiment, the interferometric geometry of FIG. 2 is selected so that a recognition-optimized optical path length satisfies the relationship:
L_rec=n*X_opt*lambda, where n is an integer greater than or equal to 1, X_opt is a recognition scaling constant, and lambda is the wavelength of the laser subsystem 30. In one preferred embodiment, X_opt=phi/pi, where phi is the golden ratio and pi is the circle constant. In some embodiments, the effective optical path length 50 corresponds to L_rec more directly than the physical arm length 48, such that cavity enhancement, multiple round trips, or folded paths are used to realize a target effective path length without requiring a matching single-pass arm dimension.

In some embodiments, the effective optical path length 50 may be expressed as:
L_eff=N_rt*L_phys, where N_rt is an effective number of round trips and L_phys is a physical arm length. A design target may therefore be selected such that L_eff approximates n*X_opt*lambda within an allowable tolerance. In some embodiments, a value of n is selected by: n= round(L_target/(X_opt*lambda)), after which the optical geometry is tuned to satisfy desired interference conditions. Such tuning may be carried out by cavity detuning, mirror position actuation, thermal compensation, or optical path folding, while still treating the recognition-optimized length as a design target rather than an absolute requirement.

In some embodiments, the “allowable tolerance” for the relationship L_eff approximately equal to n*X_opt*lambda is defined as a fractional deviation epsilon_L given by:

$$epsilon\_L = abs ( L\_eff - ( n * X\_opt * lambda ) ) / ( n * X\_opt * lambda ) .$$

In nonlimiting examples, the allowable tolerance corresponds to epsilon_L<=0.05, epsilon_L<=0.01, or epsilon_L<=0.001, depending on detector configuration and control capability. In some embodiments, performance degrades gracefully as epsilon_L increases, such that the recognition-optimized length is treated as a design target rather than an absolute requirement.

Although FIG. 2 shows an interferometric arrangement with cavities, the illustrated geometry is nonlimiting. The laser subsystem 30 may employ different wavelengths, the cavities 38 and 40 may be Fabry-Perot cavities or another resonant configuration, and the readout photodetector 46 may be used in a DC readout, heterodyne, or homodyne scheme. The geometry of FIG. 2 therefore provides one preferred embodiment class for recognition-optimized sensing while remaining compatible with different interferometer implementations.

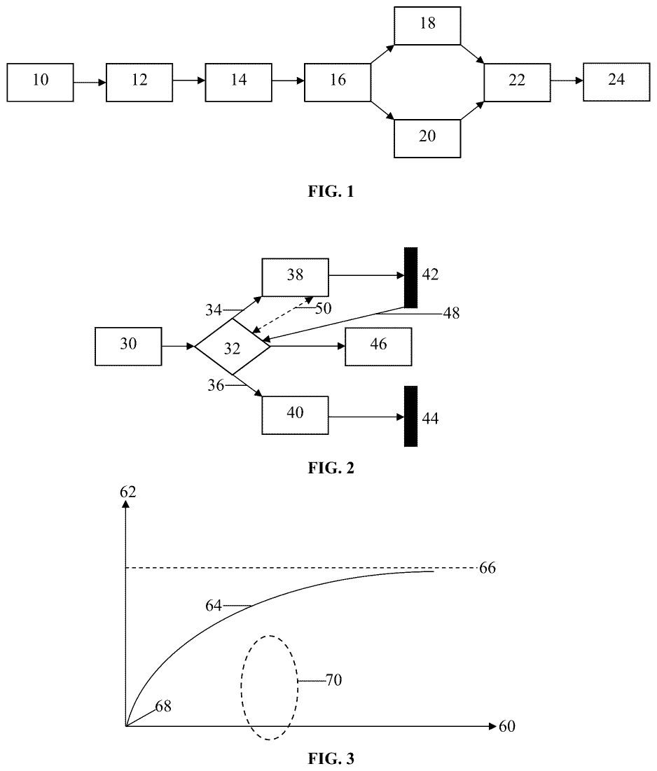

FIG. 3 illustrates a recognition coverage function. In the illustrated graph, a horizontal axis 60 represents a recognition signal parameter r, a vertical axis 62 represents a recognition coverage quantity F_cov(r), and a curve 64 shows the functional relationship between the two. In one preferred embodiment, the curve 64 is defined by:
F_cov(r)=r/(r+X_opt), for r>=0 and X_opt>0. An asymptotic upper bound 66 is shown at a value less than 1, and a zero-signal point 68 corresponds to the condition at which r=0 and the recognition coverage quantity is zero. A transition region 70 reflects the scale set by X_opt, beyond which the curve 64 continues to increase monotonically while remaining bounded below the asymptotic upper bound 66.

In one embodiment, the recognition signal parameter r is dimensionless and is defined by:

$$r = h * f * t ,$$

where h is a nonnegative strain magnitude or another nonnegative amplitude measure, f is a frequency value, and t is a time duration. In some implementations, h may be an absolute value, RMS amplitude, envelope magnitude, or band-limited amplitude computed over an analysis interval. Likewise, f may be a frequency-bin center, an instantaneous frequency estimate, or a representative band frequency, and t may be an analysis window length, an integration interval, or another time quantity appropriate for the selected processing framework. The graph of FIG. 3 therefore depicts how recognition coverage changes as a function of a dimensionless signal quantity derived from measured data.

In some embodiments, numerical safeguards are applied when computing the recognition coverage quantity associated with FIG. 3. For example, r may be forced to remain nonnegative, X_opt may be constrained to remain positive, and the computed value of F_cov(r) may be clamped to a maximum value less than 1 using an epsilon margin. These measures can improve numerical stability in downstream informational-content computation while preserving the bounded and monotone character represented by the curve 64.

FIG. 4 illustrates a multiscale recognition transform arrangement. An input signal 80, which may correspond to calibrated strain data or an equivalent signal stream, is provided to a first scale branch 82, a second scale branch 84, and a third scale branch 86. Each branch includes a recognition weighting stage 88 configured to apply a scale-dependent recognition coverage weighting, followed by a transform stage 90 configured to compute one or more recognition-weighted transform coefficients. The resulting scale-specific outputs 92 are combined in a fusion stage 94 to generate a fused recognition output 96. Although three branches are shown for clarity, the illustrated arrangement is representative of any number of scales.

In one preferred embodiment, the recognition weighting stage 88 in each branch computes a multiscale recognition coverage quantity according to:

$$F\_cov , n ( r ) = r / ( r + ( X\_opt \hat{} n ) ) ,$$

for scale index n=1, 2, 3, . . . The transform stage 90 may then compute a recognition transform coefficient for a selected frequency according to: R_n(f)=integral over t of h(t)*exp(−i2pift)*F_cov,n(h(t)ft)dt, where h(t) is a measured or inferred strain signal. In other embodiments, the transform stage 90 may implement a discrete transform, a sliding-window transform, a filter bank, a wavelet transform, a chirplet transform, an S-transform, a Wigner-Ville distribution, or another time-frequency representation, provided that recognition coverage weighting and/or multiscale recognition scaling is applied.

In one embodiment, the input signal 80 is segmented into time windows, and for each window a nonnegative amplitude quantity, a representative frequency, and a window duration are used to compute a value of r. The recognition weighting stage 88 may then compute either samplewise or tilewise weights, and the transform stage 90 may apply those weights before performing a discrete Fourier transform or another selected transform. The scale-specific outputs 92 may be complex coefficients, power values, time-frequency tiles, or feature tensors, depending on implementation. The use of multiple branches 82, 84, and 86 permits different scale settings to emphasize different recognition regimes.

The fusion stage 94 may combine the scale-specific outputs 92 in various ways. In some embodiments, the fusion stage 94 concatenates feature vectors across scales. In some embodiments, the fusion stage 94 computes a weighted sum, such as:
R_fused(f)=sum_n a_n*R_n(f), where a_n are predetermined or learned weights. In still other embodiments, the fusion stage 94 computes coherence relationships across scales or generates scale-signature features describing how recognition energy varies with scale. The fused recognition output 96 may then be supplied as an input to downstream classification or information quantification.

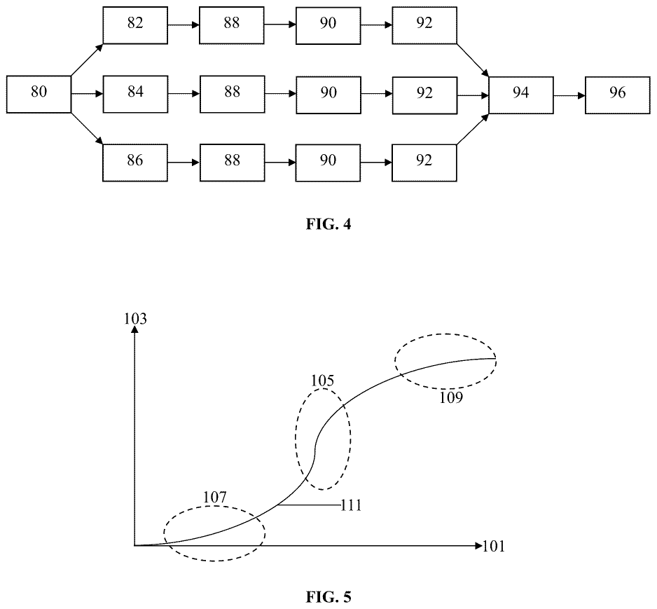

FIG. 5 illustrates an informational-content mapping associated with the recognition coverage quantity. A horizontal axis 101 represents the recognition signal parameter r, a vertical axis 103 represents informational content I(r), and a curve 105 shows the informational-content response.

A low-signal region 107 corresponds to small values of r for which informational content remains near zero. A steep-rise region 111 occurs as recognition coverage increases, and a near-saturation region 109 corresponds to values of r for which the recognition coverage quantity approaches its upper bound from below and the informational-content value rises accordingly. In one preferred embodiment, the curve 105 is defined by:

$$I ( r ) = - log 2 ( 1 - F\_cov ( r ) ) ,$$

where F_cov(r) is a bounded recognition coverage function.

In one embodiment, I(r) equals zero when F_cov(r) equals zero, and I(r) increases as F_cov(r) approaches 1 from below. In multiscale processing embodiments, the informational-content mapping may also be evaluated as:
I_n(r)=−log 2(1−F_cov,n(r)), and informational-content values may be aggregated across windows, scales, or frequency bins to obtain event-level or observation-level quantities.

Alternative monotone mappings may also be used, including natural-log forms or other strictly monotone functions of recognition coverage, while preserving the ordering of informational strength. FIG. 5 thus depicts how a bounded recognition coverage measure may be converted into a monotonically increasing informational metric.

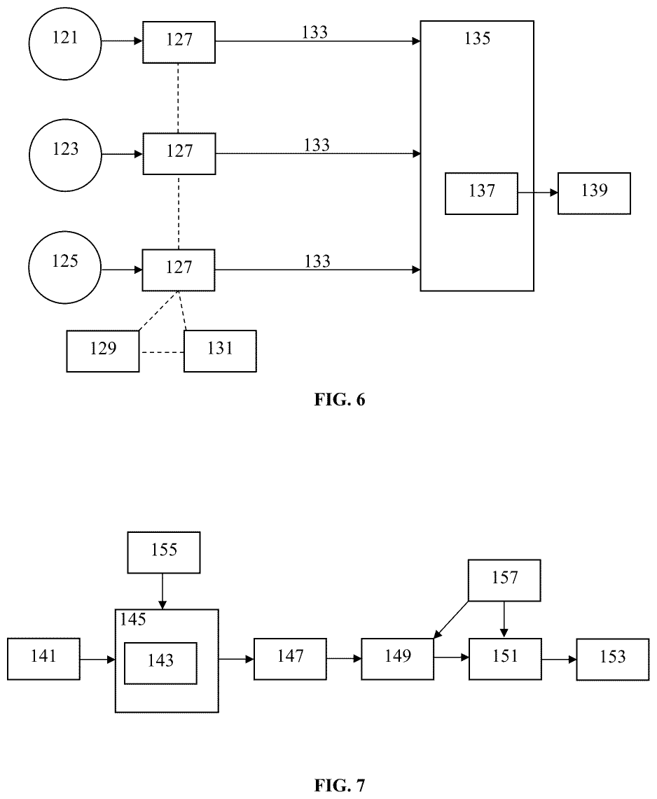

FIG. 6 illustrates a distributed detector network. A first detector node 121, a second detector node 123, and a third detector node 125 are located at distinct sites and are each associated with a local recognition transform processor 127. A time synchronization module 129 and a phase synchronization module 131 coordinate timing and phase relationships among the detector nodes. One or more communication links 133 couple the detector nodes to a fusion node 135.

The fusion node 135 includes a cross-correlation engine 137 configured to combine recognition-transform results from the detector nodes and produce a coherence output 139. Although three detector nodes are illustrated, the network may include any suitable number of terrestrial and/or spaceborne detector units.

In one embodiment, each detector node 121, 123, 125 computes recognition transforms locally and transmits raw strain data, compressed recognition transforms, extracted features, or combinations thereof over the communication links 133 to the fusion node 135 or to a distributed fusion arrangement. The time synchronization module 129 may use GPS-disciplined oscillators, atomic clocks, optical time transfer, two-way satellite time transfer, fiber time transfer, or other synchronization techniques. The phase synchronization module 131 may estimate phase offsets using calibration signals or reference lines and may maintain phase stability using phase-locked loops or digital compensation. In one embodiment, recognition-phase synchronization is maintained such that:

$$\vert arg ( R\_n , i ) - arg ( R\_n , j ) \vert <= 0.01 rad ,$$

for time intervals of interest after propagation-delay correction and calibration-offset compensation.

In one embodiment, the cross-correlation engine 137 computes, for each scale n and frequency band, a cross-detector coherence statistic according to:

$$C\_n ( f ) = sum over pairs ( i , j ) of R\_n , i ( f ) * conj ( R\_n , j ( f ) ) * w\_ij ( f ) ,$$

where w_ij(f) are weights based on detector noise, detector geometry, or both. In some embodiments, the cross-correlation engine 137 further computes: C_fused(f)=sum_n b_n*C_n(f), to combine coherence measures across scales. The coherence output 139 may then be used to improve confidence, reject local artifacts, or support detection of weak sources, including stochastic backgrounds.

The distributed arrangement of FIG. 6 is nonlimiting. The fusion node 135 may be centralized or distributed, the communication links 133 may use fiber, satellite, or other communication media, and the local recognition transform processors 127 may execute on detector-site computing hardware or on remotely coupled accelerators. FIG. 6 therefore illustrates a network architecture in which synchronized recognition-weighted processing results are coherently combined across detectors.

FIG. 7 illustrates a quantum squeezing module for use with an interferometric readout chain. In the illustrated embodiment, a pump laser 141 drives an optical parametric oscillator 143 that includes a nonlinear crystal 145 configured to generate a squeezed vacuum output 147. The squeezed vacuum output 147 is coupled to a filter cavity 149 and then directed by injection optics 151 into an interferometer readout chain 153. A phase-lock control 155 and an alignment control 157 are configured to stabilize operation of the squeezing module.

In one embodiment, the optical parametric oscillator 143 uses an appropriate nonlinear crystal, such as PPKTP, and produces squeezed vacuum at the wavelength of the interferometer readout chain 153. In some embodiments, the squeezing level is in a nonlimiting range of about 12 dB to about 15 dB. In some embodiments, the squeezing subsystem operates across a gravitational-wave detection band, such as a nonlimiting range of about 10 Hz to about 10 kHz. The filter cavity 149 may be configured to provide frequency-dependent squeezing by rotating a squeezing ellipse as a function of frequency. In some embodiments, the phase-lock control 155 and the alignment control 157 cooperate with pump stabilization and injection-path isolation to maintain stable squeezed-state delivery to the interferometer readout chain 153.

FIG. 7 is not limited to a single squeezing architecture. In some embodiments, the module may additionally or alternatively employ entanglement-assisted readout, backaction evasion, variational readout, quantum nondemolition measurement schemes, or hybrid quantum sensors, provided that the resulting quantum-enhanced signal acquisition is used in conjunction with the recognition-weighted processing described herein. The optical arrangement shown in FIG. 7 therefore illustrates one preferred embodiment class for reducing quantum noise in one or more operating bands.

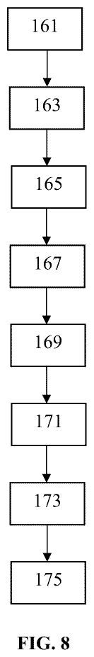

FIG. 8 illustrates a signal processing pipeline. An input data block 161, which may correspond to calibrated strain data or an equivalent detector output, is provided to a preprocessing stage 163.

The preprocessing stage 163 supplies processed data to an r-computation stage 165 configured to determine a recognition signal parameter. An F_cov computation stage 167 computes one or more recognition coverage quantities from the recognition signal parameter. A multiscale transform stage 169 computes one or more recognition-weighted transforms. A pattern classification stage 171 evaluates outputs of the multiscale transform stage 169 to identify one or more candidate signal patterns. An informational-content computation stage 173 computes one or more informational metrics, and a reporting stage 175 generates one or more outputs, including triggers, reports, or catalogs.

In one embodiment, the preprocessing stage 163 performs one or more of calibration to strain h(t) or an equivalent signal, whitening, bandpass filtering, subtraction of known noise couplings using witness channels, glitch detection and gating, segmentation into analysis windows, and estimation of instantaneous frequency content. The r-computation stage 165 may compute:

$$r = h\_amp * f\_center * T\_win ,$$

where h_amp is a nonnegative amplitude measure, f_center is a representative frequency, and T_win is a window duration. In some embodiments, h_amp is derived as a maximum absolute value, RMS value, analytic-signal envelope magnitude, or band-limited amplitude. In some embodiments, the r-computation stage 165 uses a normalized form:

$$r = ( h\_amp / sigma\_h ) * f\_center * T\_win ,$$

where sigma_h represents an estimated noise level.

In some embodiments, witness channels used for subtraction of known noise couplings include one or more environmental or auxiliary sensor channels, such as seismometer channels, magnetometer channels, microphone channels, temperature-sensor channels, actuator-line channels, or transfer-function calibration channels. In some embodiments, preprocessing uses such channels to estimate and subtract non-gravitational contributions before computation of r, F_cov(r), F_cov,n(r), or associated recognition-weighted transforms.

In one embodiment, the F_cov computation stage 167 computes:

$$F\_cov ( r ) = r / ( r + X\_opt ) ,$$

and, for multiscale operation,
F_cov,n(r)=r/(r+(X_opt\hat{ }n)). The multiscale transform stage 169 may then compute recognition-weighted transform coefficients continuously or discretely. In one embodiment, the multiscale transform stage 169 computes: R_n(f)=integral over t of h(t)*exp(−i2pift)*F_cov,n(h(t)ft)dt, and in another embodiment computes discrete weighted transforms over windows and frequency bins. The pattern classification stage 171 may compute power values, phase-coherent statistics, scale-signature statistics, posterior probabilities, likelihood ratios, or neural-network outputs. The informational-content computation stage 173 may compute: I(r)=−log 2(1−F_cov(r)), and may additionally compute multiscale informational-content values and aggregate them across windows, scales, or bands.

As used herein, an “aggregated informational content quantity” I_agg is any deterministic aggregation of informational-content values computed from recognition coverage and/or recognition-weighted transforms. In nonlimiting examples, I_agg is computed as (i) a sum across tiles, windows, or frequency bins, (ii) a weighted sum across scales, or (iii) a maximum or percentile over a window set. For example, for discrete processing over windows w, scale indices n, and frequency bins b, one implementation computes:

$$I\_agg = sum over w of sum over n of sum over b of ( alpha\_n * I\_n ( r\_w , b ) ) ,$$

where alpha_n are predetermined nonnegative scale weights and I_n(r) is a monotone informational mapping based on F_cov,n(r). Other deterministic aggregations may be used, including normalization by the number of tiles, clipping of outliers, or aggregation restricted to one or more bands.

In some embodiments, the pattern classification stage 171 comprises a Bayesian classifier, neural-network inference circuitry, or a combination thereof. In some embodiments, the Bayesian classifier operates on recognition-weighted transform features, coherence-related features, scale-signature features, or combinations thereof, and the neural-network inference circuitry operates on transform-domain tensors, feature vectors, or both.

In one embodiment, the reporting stage 175 generates event triggers, confidence intervals, informational-content summaries, or artifacts explaining which recognition scales contributed to a detection or classification outcome. The pipeline of FIG. 8 may be implemented in hardware, software, firmware, or combinations thereof, and may execute on CPUs, GPUs, FPGAs, ASICs, or combinations thereof. FIG. 8 thus illustrates one end-to-end processing flow by which detector data is converted into recognition-weighted transform results, pattern classifications, informational-content measures, and reportable outputs.

In some embodiments, the system generates an event indicator when at least one objective criterion is satisfied. Nonlimiting examples of objective criteria include: (i) an informational-content threshold test in which an event is declared when an aggregated informational content quantity I_agg exceeds a threshold I_th for at least a persistence interval T_persist; (ii) a cross-detector coherence test in which an event is declared when a coherence statistic C_fused exceeds a threshold C_th after propagation-delay correction and calibration-offset compensation; and/or (iii) a comparative baseline test in which an event is declared when a recognition-weighted score exceeds a baseline score by at least a ratio G_th or a margin Delta_th. In one nonlimiting implementation, I_th is selected based on an estimated noise level (for example using sigma_h) and may be tuned per band and per scale.

In nonlimiting examples, T_persist may be within about 5 ms to about 4 s, I_th may be within about 1 to about 20 bits for a selected aggregation definition, and/or C_th may be selected as a percentile or standard-deviation exceedance under a noise-only distribution computed from off-source windows.

Unless expressly stated otherwise, features described herein as being present in one embodiment or in some embodiments may be used alone or in combination with one another, and a recited numerical range includes its endpoints and subranges. The disclosed subject matter therefore includes implementations in which recognition-optimized sensing, quantum-enhanced acquisition, recognition coverage computation, multiscale transform processing, pattern identification, informational-content quantification, and networked correlation are combined in different subsets according to the intended detector architecture and deployment environment.

In one nonlimiting implementation example, the sensing subsystem comprises an interferometric detector having Fabry-Perot cavities and a stabilized laser source operating at approximately 1064 nm, the quantum enhancement subsystem comprises an optical parametric oscillator with a nonlinear crystal configured to generate squeezed vacuum, the multiscale processing uses scale indices n=1, 2, and 3, the recognition transform processing is executed using one or more GPUs, FPGAs, or both, and pattern classification is performed using a Bayesian classifier augmented by neural-network inference. In some implementations, such a system operates as a local detector pipeline, and in some implementations the system further participates in time-synchronized and phase-synchronized multidetector correlation.

In some embodiments, the recognition signal parameter r is computed using alternative amplitude, frequency, and time relationships while preserving dimensionless scaling. By way of nonlimiting example, the amplitude term may be derived from an absolute value, RMS amplitude, envelope magnitude, or band-limited amplitude; the frequency term may correspond to an FFT-bin center, an instantaneous-frequency estimate, or a peak spectral value; and the time term may correspond to a window length, sample interval, integration interval, or a scale-dependent time constant. In some embodiments, r is normalized by an estimated noise quantity, such as sigma_h, to improve robustness under varying noise floors.

In one preferred embodiment, the recognition scaling constant X_opt is phi/pi, which is approximately 0.515, and the recognition coverage function is F_cov(r)=r/(r+X_opt). In other embodiments, any bounded, monotone increasing coverage function may be used, including rational, logistic, or exponential forms, provided that the function maps nonnegative r to a bounded coverage quantity and supports an informational mapping. In one preferred embodiment, informational content is computed as I(r)=−log 2(1−F_cov(r)), although other monotone mappings, including natural-log forms or other strictly monotone functions g(F_cov(r)), may also be used. In some embodiments, numerical safeguards are applied by enforcing nonnegative r, enforcing positive X_opt, and clamping coverage to a value below one using an epsilon margin to improve computational stability.

In some embodiments, recognition weighting is applied in a continuous transform framework, a discrete transform framework, or both. Nonlimiting transform examples include coverage-weighted Fourier-type transforms, sliding-window transforms, filter banks, wavelet transforms, chirplet transforms, S-transforms, Wigner-Ville representations, and matched filters. Multiscale processing may employ n=1, 2, 3, or additional scales, and in some embodiments the number of scales is chosen dynamically according to signal class, frequency band, or computational constraints. Fusion across scales may be performed using concatenated features, weighted sums, coherence relationships, or scale-signature features. These operations may be implemented in software, firmware, hardware, or combinations thereof, including CPUs, GPUs, FPGAs, ASICs, edge computing at a detector site, remote accelerators, software-only retrofit processing, or hardware-assisted retrofit processing.

In some embodiments, the sensing subsystem is interferometric and may use Michelson, Fabry-Perot, dual-recycled, Sagnac, speedmeter, or Mach-Zehnder configurations. In other embodiments, the sensing subsystem may be implemented using atom interferometers, optical clock networks, resonant mass detectors, superconducting gravimeters, torsion-balance arrangements, or hybrid sensor combinations. The wavelength lambda may vary by implementation, with nonlimiting examples including about 1064 nm, about 1550 nm, about 532 nm, and about 2000 nm, and effective n selection may be adapted for the selected wavelength. In some embodiments, a recognition-optimized optical path length is treated as a design target rather than an absolute requirement, such that effective optical length may be realized through cavity enhancement, multiple bounces, or folded paths and performance may degrade gracefully with deviation from target. In some embodiments, quantum enhancement is provided by squeezed-state injection, for example using an optical parametric oscillator and nonlinear crystal, with nonlimiting squeezing levels of about 12 dB to about 15 dB over a gravitational-wave band such as about 10 Hz to about 10 kHz, optionally using frequency-dependent squeezing via a filter cavity. Other disclosed quantum-enhancement embodiments include entanglement-assisted readout, backaction evasion, variational readout, quantum nondemolition measurement schemes, and hybrid quantum sensors.

In some embodiments, the disclosed processing is used in a single-detector mode, and in some embodiments it is used in a distributed mode in which multiple detector units compute recognition transforms locally and exchange raw data, compressed transforms, or extracted features over secure, fiber, satellite, or other communication links. Time synchronization may be provided using GPS-disciplined oscillators, atomic clocks, optical time transfer, two-way satellite time transfer, fiber time transfer, or other synchronization techniques, and recognition-phase synchronization may be maintained subject to a bounded phase-difference constraint, such as less than or equal to 0.01 rad in one embodiment, after propagation-delay correction and calibration-offset compensation. Nonlimiting representative examples include compact binary coalescences, neutron-star events, stochastic background analysis, laboratory prototype verification with an effective optical path length of about 4 m using a wavelength of about 1064 nm, space-based embodiments using inter-satellite links in a millihertz band, global network deployments, continuous-wave sources, burst sources, gravitational-memory investigations, artifact rejection using recognition-weighted gating, and multimessenger-triggered window selection. Such examples are illustrative only and are not admissions of universal performance or required use cases.

The embodiments described herein are examples and do not limit the scope of the claims.

Various modifications, substitutions, and alternatives can be made without departing from the scope of the invention as defined by the claims.

What is claimed is:

1. A gravitational information extraction system, comprising:
a sensor subsystem configured to generate measurement data responsive to gravitational-wave-induced effects; and
processing circuitry in communication with the sensor subsystem and configured to:
derive, from the measurement data, a nonnegative recognition signal parameter based at least in part on an amplitude quantity, a frequency quantity, and a time quantity;
compute a recognition coverage quantity from the recognition signal parameter using a bounded monotone increasing coverage function;
compute a plurality of recognition-weighted transforms at different scales using scale-dependent recognition coverage quantities;
identify, from the plurality of recognition-weighted transforms, one or more structured informational features associated with the measurement data;
compute an informational content quantity from the recognition coverage quantity or from the plurality of recognition-weighted transforms;
compare the informational content quantity or a coherence statistic derived from the plurality of recognition-weighted transforms to at least one threshold; and
generate an output including at least one of an event indicator or a classification at least when the threshold is satisfied.

2. The system of claim 1, wherein the processing circuitry is configured to compute the recognition coverage quantity according to
$$F\_cov ( r ) = r / ( r + X\_opt ) ,$$
where r is the recognition signal parameter and X_opt is a positive recognition scaling constant.

3. The system of claim 1, wherein the processing circuitry is configured to determine that the at least one threshold is satisfied when the informational content quantity or the coherence statistic satisfies the at least one threshold for at least a persistence interval.

4. The system of claim 1, wherein the sensor subsystem comprises an interferometric detector having an effective optical path length selected such that L_eff approximates n*X_opt*lambda within an allowable tolerance, wherein the allowable tolerance corresponds to a fractional deviation epsilon_L of no greater than 5% from n*X_opt*lambda, where n is an integer greater than or equal to 1, X_opt is a recognition scaling constant, and lambda is a wavelength associated with a laser source.

5. The system of claim 4, wherein the effective optical path length is realized by cavity enhancement, multiple bounces, folded optical paths, or a combination thereof.

6. The system of claim 1, further comprising a quantum enhancement subsystem configured to enhance sensitivity in one or more frequency bands, wherein the quantum enhancement subsystem comprises an optical parametric oscillator, a nonlinear crystal, a filter cavity, and injection optics configured to inject a squeezed optical state into an interferometric readout chain.

7. The system of claim 1, wherein the processing circuitry is configured to compute scale-dependent recognition coverage quantities according to
$$F\_cov , n ( r ) = r / ( r + ( X\_opt \hat{} n ) ) ,$$
for a plurality of scale indices n.

8. The system of claim 1, further comprising a network interface and a cross-correlation module configured to receive recognition-transform results from multiple detector nodes, apply propagation-delay corrections and calibration offsets, maintain recognition-phase synchronization by maintaining a bounded phase difference between recognition transforms from different detector nodes, and compute a cross-detector coherence statistic from the recognition-transform results.

9. A method for extracting informational content from gravitational-wave measurements, comprising:
receiving measurement data from a sensor subsystem responsive to gravitational-wave-induced effects;
deriving, from the measurement data, a recognition signal parameter based at least in part on an amplitude quantity, a frequency quantity, and a time quantity;
computing a recognition coverage quantity from the recognition signal parameter;
computing, at a plurality of scales, recognition-weighted transforms using scale-dependent recognition coverage quantities;
identifying one or more structured informational features from the recognition-weighted transforms;
computing an informational content quantity;
comparing the informational content quantity or a coherence statistic to a threshold; and
generating an output including at least one of an event indicator, a classification, a report, or a correlation result at least when the threshold is satisfied.

10. A method according to claim 9, wherein the recognition signal parameter is defined as
$$r = h * f * t ,$$
where h is a nonnegative strain magnitude or derived amplitude measure, f is a frequency quantity, and t is an analysis time interval.

11. A method according to claim 9, wherein computing the recognition coverage quantity comprises computing
$$F\_cov ( r ) = r / ( r + X\_opt ) ,$$
where X_opt is positive.

12. A method according to claim 9, further comprising preprocessing the measurement data by performing calibration to strain or an equivalent signal, whitening, bandpass filtering, subtraction of known noise couplings using one or more witness channels, glitch detection and gating, segmentation into analysis windows, or a combination thereof, before deriving the recognition signal parameter.

13. A method according to claim 9, wherein deriving the recognition signal parameter comprises computing
$$r = ( h\_amp / sigma\_h ) * f\_center * T\_win ,$$
where h_amp is a nonnegative amplitude measure, sigma_h is an estimated noise level, f_center is a representative frequency, and T_win is a window duration.

14. A method according to claim 9, wherein the informational content quantity is computed according to
$$I ( r ) = - log 2 ( 1 - F\_cov ( r ) ) .$$

15. A method according to claim 9, further comprising receiving recognition-transform results from multiple detector nodes, applying propagation-delay corrections and calibration offsets, maintaining a bounded phase difference between (i) a first complex recognition-transform coefficient R_{n,i} and (ii) a second complex recognition-transform coefficient R_{n,j} such that |arg(R_{n,i})−arg(R_{n,j})|<=0.01 rad for time intervals of interest, and computing a cross-detector coherence statistic from the recognition-transform results.

16. A non-transitory computer-readable medium storing instructions that, when executed by one or more processors, cause the one or more processors to:
receive measurement data generated by a sensor subsystem responsive to gravitational-wave-induced effects;
derive a nonnegative recognition signal parameter from the measurement data;
compute a recognition coverage quantity from the recognition signal parameter using a bounded monotone increasing coverage function;
compute a plurality of recognition-weighted transforms at different scales using scale-dependent recognition coverage quantities;
identify one or more structured informational features from the plurality of recognition-weighted transforms;
compute an informational content quantity from the recognition coverage quantity or from the plurality of recognition-weighted transforms;
compare the informational content quantity or a coherence statistic derived from the plurality of recognition-weighted transforms to at least one threshold; and
generate the output including at least one of an event indicator, a classification, a report, or a correlation result at least when the threshold is satisfied.

17. The non-transitory computer-readable medium of claim 16, wherein the instructions cause the one or more processors to compute scale-dependent recognition coverage quantities according to
$$F\_cov , n ( r ) = r / ( r + ( X\_opt \hat{} n ) ) ,$$
for scale indices n=1, 2, 3, . . . .

18. The non-transitory computer-readable medium of claim 16, wherein the instructions cause the one or more processors to compute, for each of a plurality of windows and frequency bins, recognition-weighted transform coefficients by applying a scale-dependent recognition coverage weight to a windowed strain signal and performing a discrete transform to obtain the coefficients.

19. The non-transitory computer-readable medium of claim 16, wherein the threshold is selected based at least in part on an estimated noise level sigma_h computed from one or more off-source windows.

20. The non-transitory computer-readable medium of claim 16, wherein the instructions cause the one or more processors to apply propagation-delay corrections and calibration offsets to recognition-transform results from multiple detectors, maintain a bounded phase difference of no greater than 0.01 rad between recognition transforms from different detectors for time intervals of interest, and compute a coherence output using time-synchronized and phase-synchronized cross-correlation of the recognition-transform results.
